(19) United States
(12) Patent Application Publication
(10) Pub. No.: US 2021/0093903 A1
(43) Pub. Date: Apr. 1, 2021

(54) GARMENT-SUPPORTED AIR-PURIFYING FACE MASK FILTRATION SYSTEMS

(71) Applicant: Empowered Startups Ltd., Vancouver (CA)

(72) Inventors: Chris EDWARDS, Ottawa (CA); James HENDERSON, Gatineau (CA); Elmien DICKER, Vancouver (CA)

(21) Appl. No.: 16/954,806

(22) PCT Filed: Dec. 20, 2018
(86) PCT No.: PCT/CA2018/051630

§ 371 Date: Jun. 17, 2020

Related U.S. Application Data
(60) Provisional application No. 62/609,068, filed on Dec. 21, 2017.

(51) Int. Cl. A62B 23/02; A41D 13/11; A41D 23/00; A62B 18/02; A42B 3/28

(52) U.S. Cl. CPC A62B 23/02; A41D 13/1161; A42B 3/286; A62B 18/025; A41D 23/00

(57) ABSTRACT

A wearable, garment-supported air-purification system has a source of filtered forced air communicating with a face mask filter for securing over a user's mouth and nose. The source of filtered forced air is supported in the garment, such as a scarf, at a location spaced from the face filter mask. The source of filtered forced air communicates with the face filter mask through a closed air channel such as a flexible hose.

### REFERENCE TO RELATED APPLICATIONS

The present application claims the benefits, under 35 U.S.C. § 119(e), of U.S. Provisional Application Ser. No. 62/609,068 filed Dec. 21, 2017 entitled “GARMENT-SUPPORTED AIR-PURIFYING FACE MASK FILTRATION SYSTEMS” which is incorporated herein by this reference.

### TECHNICAL FIELD

The invention relates to air-purifying face mask air filtration systems for routine daily use and garments for supporting such an air filtration system.

### BACKGROUND

Face-worn air filters to protect urban dwellers from pollution during routine daily activities such as commuting have become very common in many countries due to harmful levels of air pollution in many cities. Typically they take the form of a shaped piece of filter material covering the user's mouth and nose and secured to the user's face by straps or ear loops. A traditional face-worn air filter mask is a laminated composition of several non-woven materials including the actual filter material. This is done to provide structure to the shape and comfort to the end user.

One of the issues with these designs is that they often do not seal well against the user's face and so unfiltered air is inhaled by the user. In those applications where the filter mask does seal tightly to the user's face, it will be difficult for the user when breathing normally to inhale enough air through the filter to maintain the necessary oxygen supply, particularly where the user is doing a strenuous activity such as running or riding a bicycle. Consequently the user is forced to expend extra energy breathing heavily to obtain sufficient oxygen. One known approach to this problem is to attach to the face mask filter a miniature electric fan to blow filtered air from outside the filter mask toward the mouth and nose of the wearer. However such designs have not been useful since the air flow to the user has still been insufficient and the placement of the electric fan is uncomfortable for the user.

There is therefore a general desire to provide a face-worn air filter which has increased air flow to the user's mouth or nose and can be worn comfortably.

The foregoing examples of the related art and limitations related thereto are intended to be illustrative and not exclusive. Other limitations of the related art will become apparent to those of skill in the art upon a reading of the specification and a study of the drawings.

### SUMMARY

The following embodiments and aspects thereof are described and illustrated in conjunction with systems, tools and methods which are meant to be exemplary and illustrative, not limiting in scope. In various embodiments, one or more of the above-described problems have been reduced or eliminated, while other embodiments are directed to other improvements.

The present embodiment provides a wearable, garment supported air-purification system in which a miniature electric fan provides a filtered forced air source. One aspect of the invention provides a fan-driven filtered air source incorporated into a scarf, bandana or similar garment. The fan is held in a filtration housing removably supported in a pocket in the garment and which provides filtered forced air through a flexible conduit to a separate face mask filter mounted on the user's face and which covers the user's mouth and nose.

More particularly there is provided a wearable, garment-supported air-purification system comprising a source of filtered forced air communicating with a face mask filter for securing over a user's mouth and nose wherein the source of filtered forced air is supported in the garment at a location spaced from the face filter mask and communicates with the face filter mask through a closed air channel. The face filter mask may comprise an air inlet for receiving filtered forced air and an air exhaust outlet. The face mask filter may comprise a replaceable layer of filter material. The face filter mask may comprise an air inlet for receiving filtered forced air and an air exhaust outlet. The face mask filter may comprise a replaceable layer of filter material. The source of filtered forced air may comprise a housing having an air inlet and an air outlet, an electric fan mounted in the housing to draw air into said housing through said air inlet and expel air out of said housing to said closed air channel, and an air filter mounted to filter air entering said housing. The closed air channel may comprise a flexible tube.

According to different embodiments the garment for the wearable, garment-supported air-purification system may be scarves, sweaters, bandanas or balaclavas. Preferably the face mask filter is removably secured to an inner surface of the garment and the source of filtered forced air is removably supported adjacent an inner surface of the garment. Preferably the closed air channel is connected to the side of the face mask filter farthest from a user's face when the user is wearing the garment-supported air-purification system.

The present embodiment further encompasses an active air-purifying system held within a scarf-like structure. The active air-purifying system uses an electric fan to draw air through a filter and push air up to the end user's face. The air inlet (filter end) and outlet (face-worn mask) are at opposite ends of a sealed air flow path. The face-worn mask also contains a filter that covers the user's mouth and nose. Excess air held within the face-worn mask is allowed to escape through a one-way valve situated on the face-worn mask.

In addition to the exemplary aspects and embodiments described above, further aspects and embodiments will become apparent by reference to the drawings and by study of the following detailed descriptions.

### BRIEF DESCRIPTION OF THE DRAWINGS

Exemplary embodiments are illustrated in referenced figures of the drawings. It is intended that the embodiments and figures disclosed herein are to be considered illustrative rather than restrictive.

FIG. 1 is a perspective view of an embodiment of the garment mounted air-purifying face mask filtration system as embodied in an air-purifying scarf being worn by a user.

FIG. 2 is a perspective view of the air-purifying scarf shown in FIG. 1 being put on or removed by the user.

FIG. 3 is front view of an embodiment of the air-purifying scarf shown in FIG. 1.

FIG. 4A is a rear view of the embodiment shown in FIG. 3 without the fan/air purifier unit installed, and with the mask liner removed, for purposes of illustration.

FIG. 4B is a detail of the front of the right end of the embodiment shown in FIG. 4A with tie straps tightened around the scarf end.

FIG. 4C is a detail of the embodiment shown in FIG. 4A showing the connection of the mask to the scarf.

FIG. 5 is a front view of an embodiment of a filter mask for use in the air-purifying scarf.

FIG. 6 is a rear view of an embodiment of a filter mask as shown in FIG. 5 for use in the air-purifying scarf.

FIG. 7A is a front view of an embodiment of a fan/filter enclosure for use in the air-purifying scarf.

FIG. 7B is a top view of the embodiment of a fan/filter enclosure shown in FIG. 7A.

FIG. 7C is an exploded view of the embodiment of a fan/filter enclosure shown in FIG. 7A.

FIG. 8 is a rear perspective view of an embodiment of the air-purifying scarf with the fan/air purifier unit and the filter mask installed, with the zippered slip pocket partially cut away for purposes of illustration.

FIG. 9 is a partial detail of the rear perspective view of the embodiment of the air-purifying scarf shown in FIG. 8.

FIG. 10 is an exploded rear perspective view of the embodiment of the air-purifying scarf shown in FIG. 8.

FIG. 11 is a partial detail of the exploded rear perspective view of the embodiment of the air-purifying scarf shown in FIG. 10.

FIG. 12 is a front view of the embodiment of the air-purifying scarf shown in FIG. 1 being worn by a user.

FIG. 13 is a front view of the embodiment of the air-purifying scarf shown in FIG. 12 being worn by a user in which the central portion of the scarf is transparent to illustrate the location of the fan unit and filter mask and showing the direction of air flow.

### DESCRIPTION

Throughout the following description specific details are set forth in order to provide a more thorough understanding to persons skilled in the art. However, well known elements may not have been shown or described in detail to avoid unnecessarily obscuring the disclosure. Accordingly, the description and drawings are to be regarded in an illustrative, rather than a restrictive, sense.

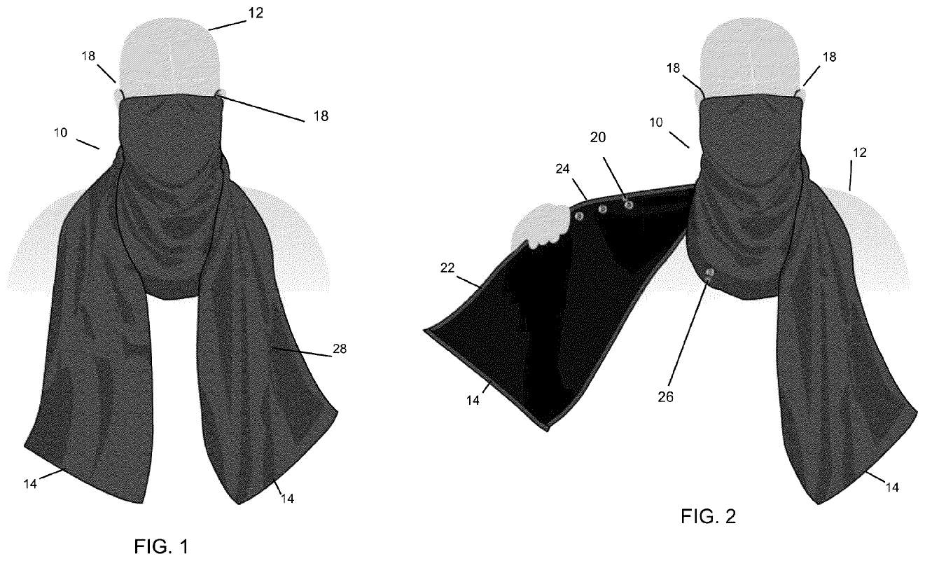

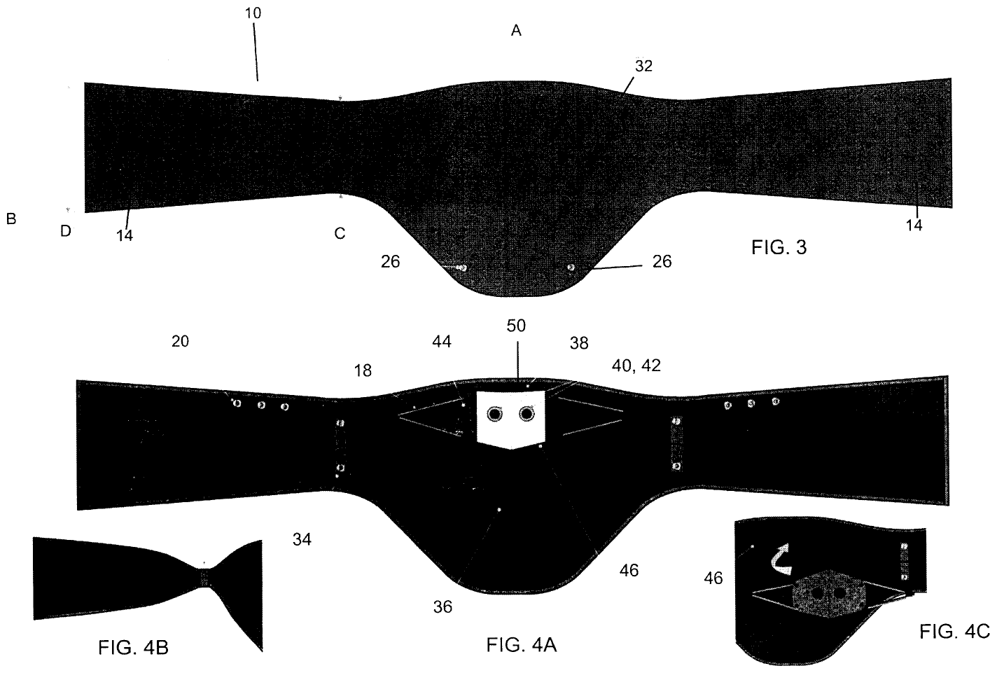

An embodiment of the air-purifying system supported by a scarf 10 is shown in FIGS. 1 and 2 in use on the wearer 12. Ends 14 of scarf 10 are wrapped around the neck of the wearer 12 with the central facial area 32 of the scarf 10 and attached air filter mask 50 (FIG. 3) held in place by adjustable elastic ear straps 18. Female metal or polypropylene snap fasteners or magnetic patches 20 are secured to the inner lining 22 of scarf 10 in a linear array along an edge 24 of the scarf. The female snap fasteners 20 can be releasably and selectively secured to metal male snap fasteners 26 on the outer surface 28 of scarf 10 adjacent an edge thereof to allow adjustment and securing of the scarf 10 around user 12's neck. Female snap fasteners 20 may be replaced with other securement means, such as small magnetic metal plates, in which case male metal snap fastener 26 is replaced with a small magnet. The outer surface 28 of scarf 10 may be a soft, warm material such as Kashmir jacketing, while the inner surface 22 may be a lighter more functional material such as satin crepon (for example). Other useful fabrics for the garment will be apparent to those skilled in the art.

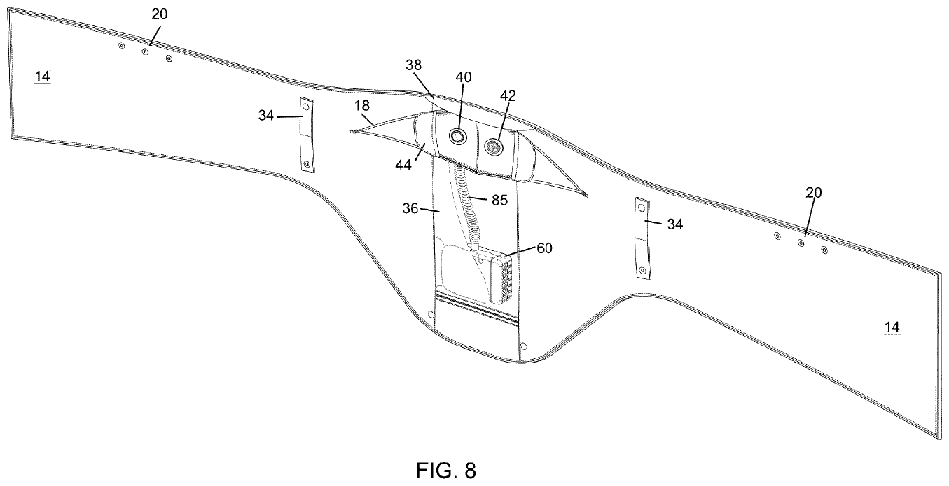

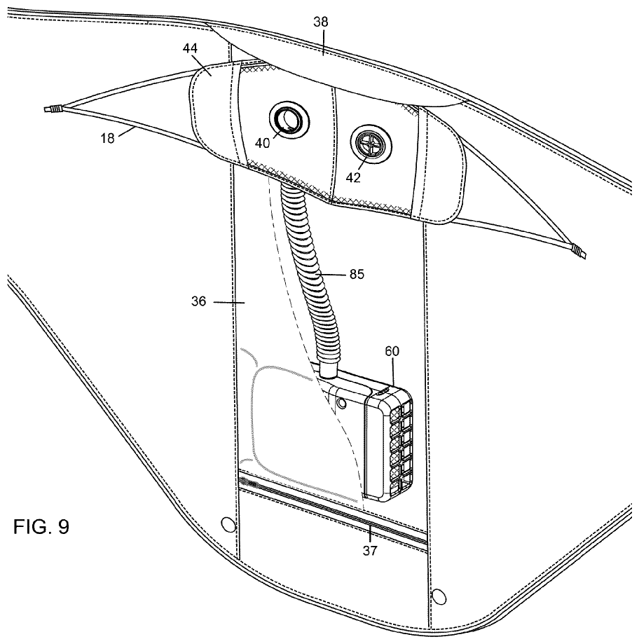

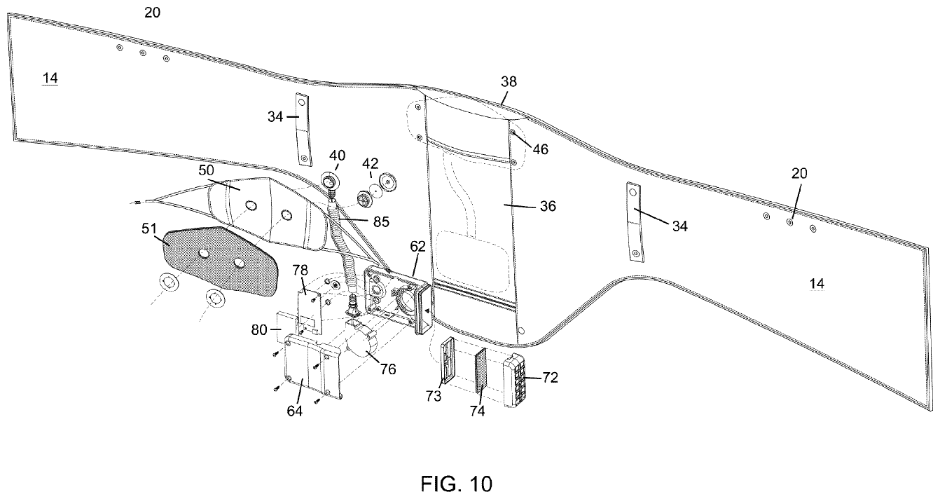

With reference to FIG. 3, the scarf 10 is shown laid out horizontally in front view, showing ends 14 and the facial covering area 32. According to one embodiment for adults, the total length A of the scarf may be about 200 cm, and the height B of the facial area 32 may be about 50 cm. The height D of the ends 14 may be about 30 cm at the ends and a reduced height, for example 20 cm, may be provided at point C closer to the central facial area 32. FIG. 4A shows a rear view of the scarf 10 without the fan/air purifier unit installed. Tie straps 34 with snaps or hook and loop fastener ends may be used to gather scarf 10 to assist in wrapping the scarf around the user's neck as shown in FIG. 4B. An air purifier unit zippered slip pocket 36, as further described in FIG. 8, may be formed in the interior liner 22 to receive the fan/air purifier unit 60. A velour nose piece cover 38, shown also in FIG. 8, is secured to the interior liner 22 in the area intended for the user's nose when the scarf 10 is worn by the user, and holes to receive air intake and exhaust valves 40, 42 (see FIG. 9) are provided in the filter face mask 50 to facilitate the passage of forced air to and from the user's nose. Velour material is also provided in the vicinity of nose piece cover 38 for padding to increase the comfort of the device when worn. The air filter mask 50 (see FIGS. 4C and 5, 6) has male snap fasteners 54 which releasably attach to female snaps 46 (FIG. 10, 11).

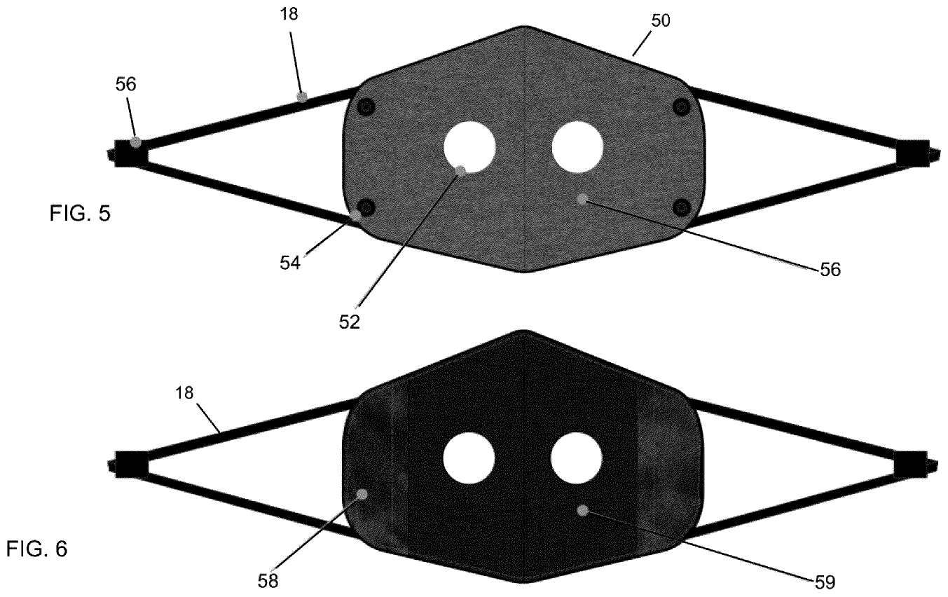

FIGS. 5 and 6 illustrate the air filter mask 50 which may be used in the embodiment in front and rear views respectively. It has die cut holes 52 for receiving air intake and exhaust valves 40, 42 (see FIG. 9). Die cut holes are where the air inlet 40 (outlet from the air purifying system) and the excess air outlet ports 42 reside. Attached elastic webbing ear straps 18 serve to secure mask 50 around the user's ears. Male snaps 54 are releasably secured to female snaps 46 on the scarf interior surface to releasably secure the filter mask 50 in place on the scarf interior. The outer surface 56 of the filter mask 50 may be a warm material such as winter jersey while the inner surface 58 may be a stretch velour to conform to the user's face. Other useful materials for the filter mask 50 will be apparent to those skilled in the art. Holder wings 44 capture and secure the ends of a removable/replaceable filter 51 shown in FIGS. 8 and 9.

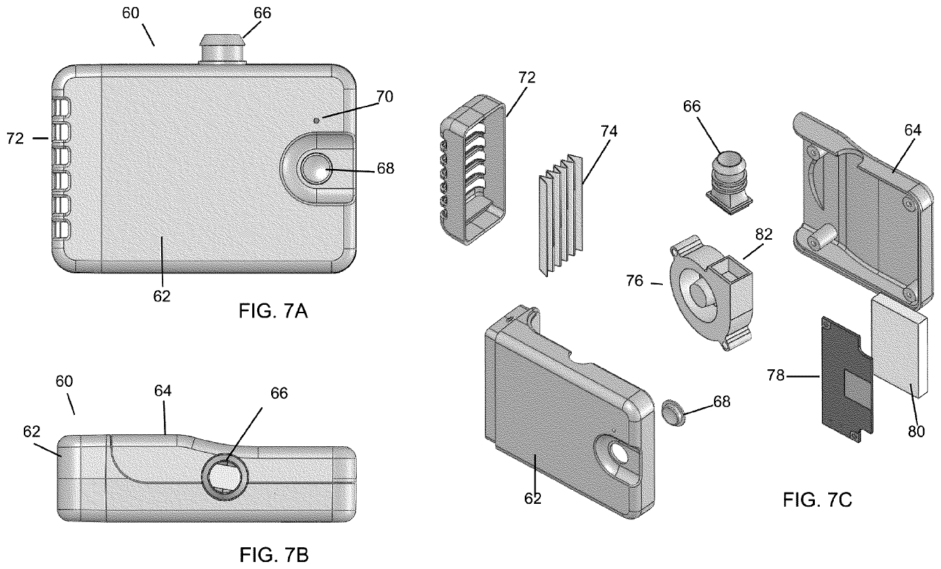

FIG. 7A, 7B, 7C illustrate the fan filter enclosure 60. It comprises front and rear housing halves 62, 64 and filter cover 72. Housing 60 encloses a filter 74, preferably flat as shown in FIG. 10, which is sized to be positioned within filter cover 72 to filter incoming air, and electric fan 76. Fan 76 has a forced air outlet 82 which communicates with fan transition 66 which carries the forced air outside the enclosure 60 to the filter mask 50 through air hose 85. Printed circuit board 78 is programmed to control the fan 76, and has power supplied by battery 80 which may be a 1500 milliampere hour battery. Button 68 allows the user to select power on/off and fan speed. Printed circuit board 78 may have a mini USB connector and Bluetooth chip.

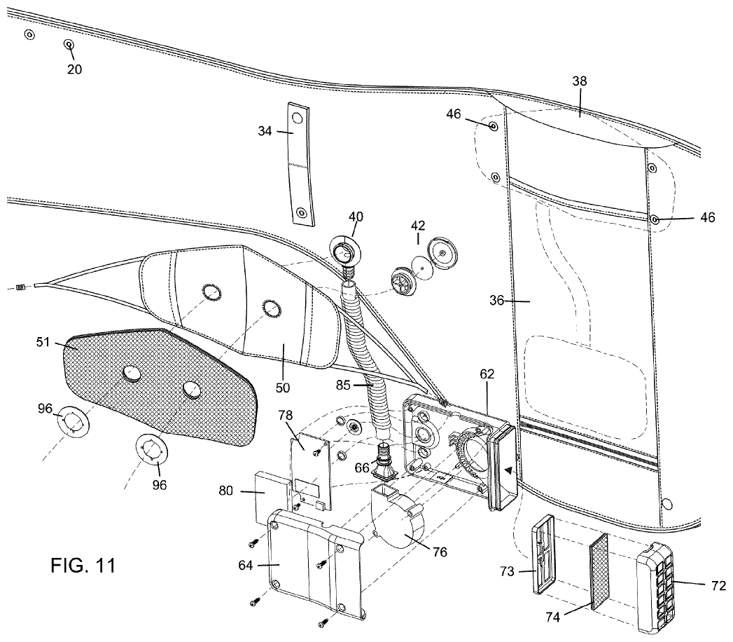

FIG. 8 is a rear perspective view of an embodiment of the air-purifying scarf 10 with the fan/air purifier unit 60 and the filter mask 50 installed, with the zippered slip pocket 36 partially cut away for purposes of illustration. FIG. 9 is a partial detail of the rear perspective view of the embodiment of the air-purifying scarf shown in FIG. 8. The fan filter enclosure 60 may be held in slip pocket 36 which is closed by hook and loop strips or a zipper 37. The fan transition 66 connects to air hose 85 which connects to air intake release 40 and is secured to mask 50 and mask liner 51 by connector 96 (FIG. 11). Exhaust valve is shown at 42 and is also secured to mask 50 by connector 96. Face filter 51 forms a pocket around face filter mask 50 when installed.

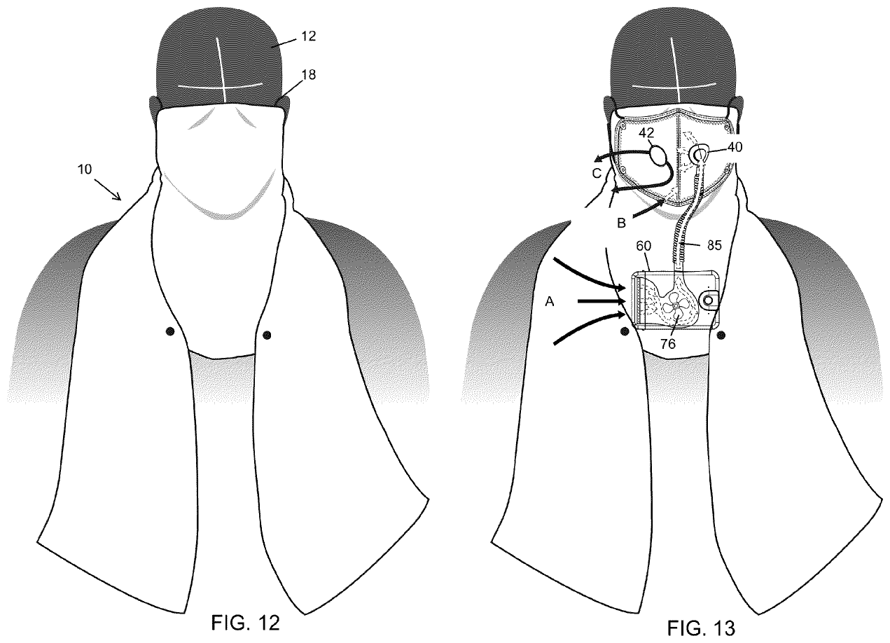

FIG. 10 is an exploded rear perspective view of the embodiment of the air-purifying scarf shown in FIG. 8. FIG. 11 is a partial detail of the exploded rear perspective view of the embodiment of the air-purifying scarf shown in FIG. 10. FIG. 12 is a front view of the embodiment of the air-purifying scarf 10 shown in FIG. 1 being worn a user. FIG. 13 is a front view of the embodiment of the air-purifying scarf shown in FIG. 12 being worn a user in which the central portion of the scarf 10 is transparent to illustrate the location of the fan unit 60 and filter mask 50 and showing the direction of air flow by way of arrows A, B, C. External air A flows into filter unit 60, through filter 74 and is forced by fan 76 into air hose 85. Hose 85 connects to air intake release 40 in mask 50. External air at B is also drawn directly through filter mask 50 through filter 51 to the user's mouth and nose. Exhaled exhaust air is driven out at C through exhaust valve 42.

While scarves have been disclosed as an embodiment of the garment for supporting the air-purifying face mask filtration system, other similar types of garments such as bandanas, turtle-neck sweaters or balaclavas may provide the same function.

While a number of exemplary aspects and embodiments have been discussed above, those of skill in the art will recognize certain modifications, permutations, additions and sub-combinations thereof. It is therefore intended that the following appended claims and claims hereafter introduced are interpreted to include all such modifications, permutations, additions and sub-combinations as are consistent with the broadest interpretation of the specification as a whole.

1. A wearable, garment-supported air-purification system comprising a source of filtered forced air communicating with an air filter mask mounted in said garment for securing over a user's mouth and/or nose wherein said source of filtered forced air is supported in said garment at a location spaced from said air filter mask and communicates with said air filter mask through a closed air channel; and wherein said source of filtered forced air comprises a housing having an air inlet and an air outlet, an electric fan mounted in said housing to draw air into said housing through said air inlet and expel air out of said housing to said closed air channel, and an air filter mounted to filter air entering said housing.

2. The wearable, garment-supported air-purification system of claim 1 wherein said air filter mask comprises an air inlet for receiving filtered forced air from said source of filtered forced air and an air exhaust outlet.

3. (canceled)

4. (canceled)

5. The wearable, garment-supported air-purification system of claim 1 wherein said air filter mask comprises a replaceable layer of filter material whereby air may reach said user's mouth and/or nose both through said air filter mask and from said source of filtered forced air.

6. (canceled)

7. The wearable, garment-supported air-purification system of claim 1 wherein said closed air channel comprises a flexible tube.

8. The wearable, garment-supported air-purification system of claim 1 wherein said garment is selected form the group comprising scarves, sweaters, bandanas and balaclavas.

9. The wearable, garment-supported air-purification system of claim 1 wherein said air filter mask is removably secured to an inner surface of said garment.

10. The wearable, garment-supported air-purification system of claim 1 wherein said source of filtered forced air is removably supported on, in or adjacent to an inner surface of said garment.

11. The wearable, garment-supported air-purification system of claim 1 wherein said closed air channel is connected to the side of the air filter mask farthest from a user's face when said user is wearing said garment-supported air-purification system.

12. The wearable, garment-supported air-purification system of claim 9 wherein said air filter mask is provided with ear straps which removably secure said air mask to said user's ears.

13. The wearable, garment-supported air-purification system of claim 2 wherein said air outlet is provided with an air exhaust valve.

14. The wearable, garment-supported air-purification system of claim 1 wherein said source of filtered forced air is removably supported on, in or adjacent to an inner surface of said garment in a reversibly closable pocket formed in said garment.
